(19) United States
(12) Patent Application Publication
(10) Pub. No.: US 2019/0004926 A1
(43) Pub. Date: Jan. 3, 2019

(54) METHODS AND SYSTEMS THAT PROBABILISTICALLY GENERATE TESTING LOADS

(71) Applicant: NICIRA, INC., Palo Alto, CA (US)

(72) Inventor: SUDHEENDRA BANGALORE KRISHNAMURTHY, Bangalore (IN)

(21) Appl. No.: 15/813,183

(22) Filed: Nov. 15, 2017

(30) Foreign Application Priority Data
Jun. 29, 2017 (IN) 201741022850

(51) Int. Cl. G06F 11/36; G06N 7/00; G06F 7/58

(52) U.S. Cl. CPC G06F 11/368; G06F 7/58; G06N 7/005

(57) ABSTRACT

The current document is directed to methods and systems that probabilistically generate testing loads according to a state-transition model or finite-state-machine model. The system employs a random walk of a state-transition model and specified state-transition probabilities or specified distributions of state probabilities. In certain implementations, the generated load comprises a series of requests or commands that are issued by a testing system or testing application and that conform to a particular client/server protocol. The requests and commands are selected by pseudorandom processes. In described implementations, the requests or commands are generated by a Markov-chain process based on a state-transition model.

### RELATED APPLICATION

Benefit is claimed under 35 U.S.C. 119(a)-(d) to Foreign Application Serial No. 201741022850 filed in India entitled “METHODS AND SYSTEMS THAT PROBABILISTICALLY GENERATE TESTING LOADS”, filed on Jun. 29, 2017, by Nicira, Inc., which is herein incorporated in its entirety by reference for all purposes.

### TECHNICAL FIELD

The current document is directed to methods and systems that test electronic devices, including computer systems, and, in particular, to methods and systems that probabilistically generate testing loads.

### BACKGROUND

Computer systems have evolved enormously in the past 60 years. Initial computer systems were room-sized, vacuum-tube-based behemoths with far smaller computational bandwidths and smaller data-storage capacities than a modern smart phone or even a microprocessor-based controller embedded in any of various consumer appliances and devices. Initial computer systems ran primitive programs one at a time, without the benefit of operating systems, high-level languages, and networking. Over time, parallel development of hardware, compilers, operating systems, virtualization technologies, and distributed-computing technologies has led to modem distributed computing systems, including cloud-computing facilities, that feature hundreds, thousands, tens of thousands, or more high-end servers, each including multiple multi-core processors, that can access remote computer systems and that can be accessed by remote client computers throughout the world through sophisticated electronic communications. As the complexity of computer systems has grown, the complexity of, and computational-resource overheads associated with, testing of computer systems and other electronic devices has correspondingly increased. For this reason, designers, developers, vendors, and, ultimately, users of computer systems continue to seek methods and subsystems to more efficiently test electronic devices, including computer systems.

### SUMMARY

The current document is directed to methods and systems that probabilistically generate testing loads according to a state-transition model or finite-state-machine model. The system employs a random walk of a state-transition model and specified state-transition probabilities or specified distributions of state probabilities. In certain implementations, the generated load comprises a series of requests or commands that are issued by a testing system or testing application and that conform to a particular client/server protocol. The requests and commands are selected by pseudorandom processes. In described implementations, the requests or commands are generated by a Markov-chain process based on a state-transition model.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate several types of virtual machine and virtual-machine execution environments.

FIGS. 6A-B illustrate common testing scenarios.

FIG. 7 illustrates a simple state-transition diagram for a target system under test.

FIG. 8 illustrates a generalized request/response-transaction-based interaction between a testing system and a target system.

FIG. 9 shows a two-dimensional matrix that represents both the states and state transitions shown in, the state-transition model in FIG. 7 as well as the request/response protocol illustrated in FIG. 8 that is represented by the function pr( ).

FIGS. 10A-B illustrate two possible approaches to testing based on a request/response-transaction protocol.

FIG. 11 illustrates assignment of probabilities to the state-transition diagram shown in FIG. 7 to create the basis for a Markov process.

FIG. 12 illustrates a matrix encoding of the representation of the Markov process shown in FIG. 11.

FIG. 13 illustrates a method for choosing a next state during a random walk of a state-transition model.

FIGS. 14-16 illustrate features of a second disclosed probabilistic testing method.

FIG. 17 illustrates a test file, similar to the test files previously described with reference to FIGS. 10A-B, used to encode the two different types of probabilistic tests that represent examples of the currently disclosed probabilistic testing methods.

FIGS. 18A-D show control-flow diagrams that illustrate one implementation of a testing application that uses a test file, such as the test file illustrated in FIG. 17, to run a test specified by the information contained in the test file.

FIG. 19 illustrates the nature of probabilistic load generation for testing purposes.

### DETAILED DESCRIPTION OF EMBODIMENTS

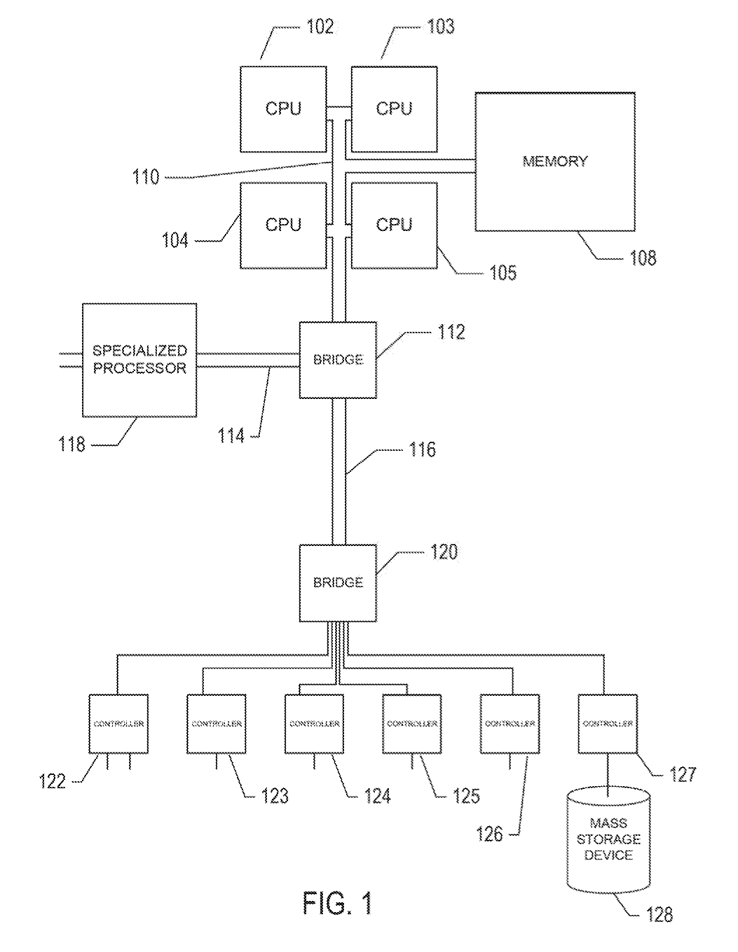

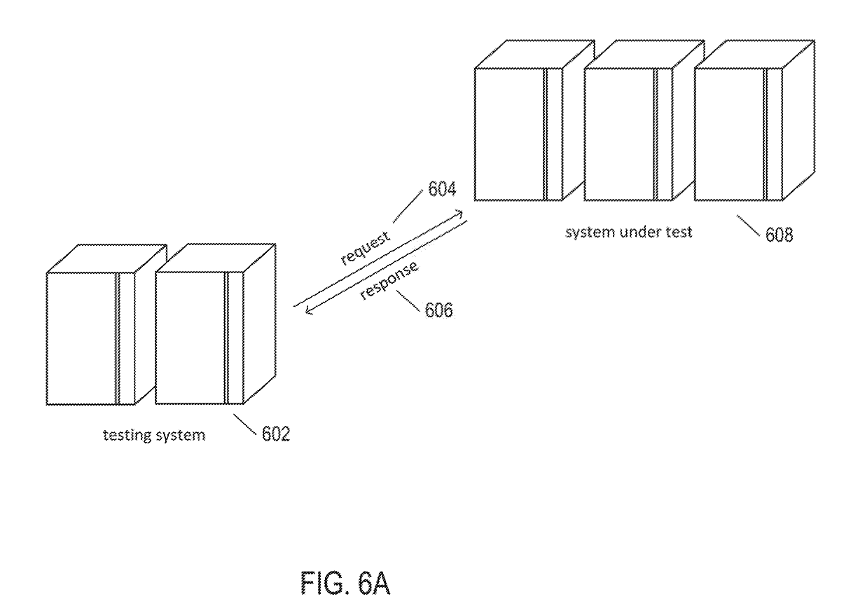

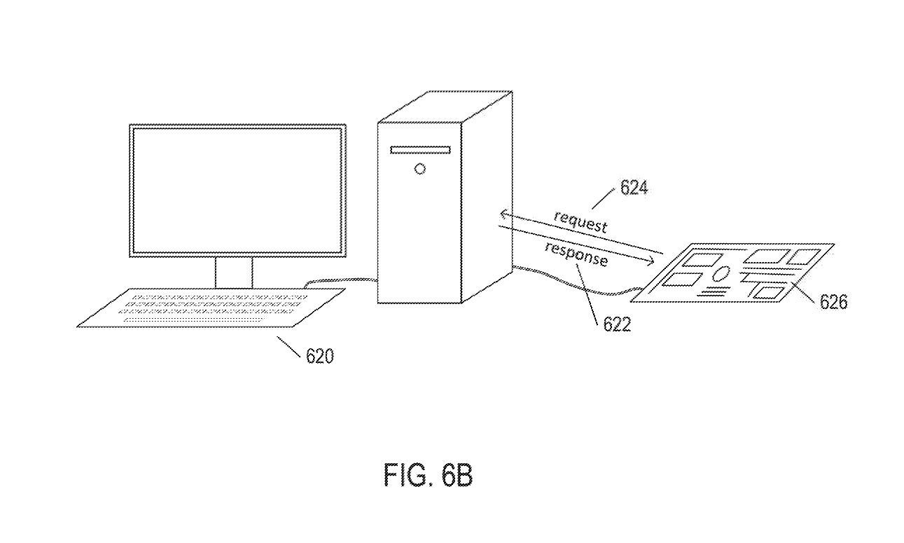

The current document is directed to methods and systems that test electronic devices, including computer systems, and, in particular, to methods and systems that probabilistically generate testing loads using a Markov process represented by a state-transition model and specified state-transition probabilities and/or specified state-probability distributions. In a first subsection, below, an overview of computer systems is provided with reference to FIGS. 1-5D. In a second subsection, the methods and subsystems to which the current document is directed are discussed with reference to FIGS. 6A-19.

### Overview of Computer Systems

FIG. 1 provides a general architectural diagram for various types of computers. The computer system contains one or multiple central processing units (“CPUs”), 102-105, one, or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized, processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

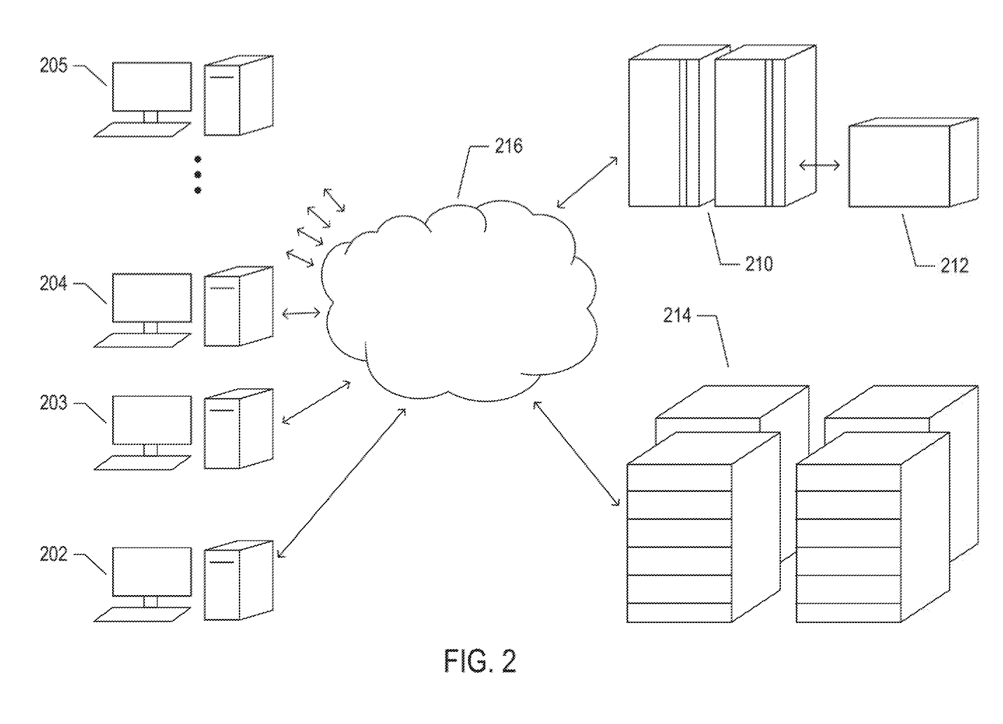

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

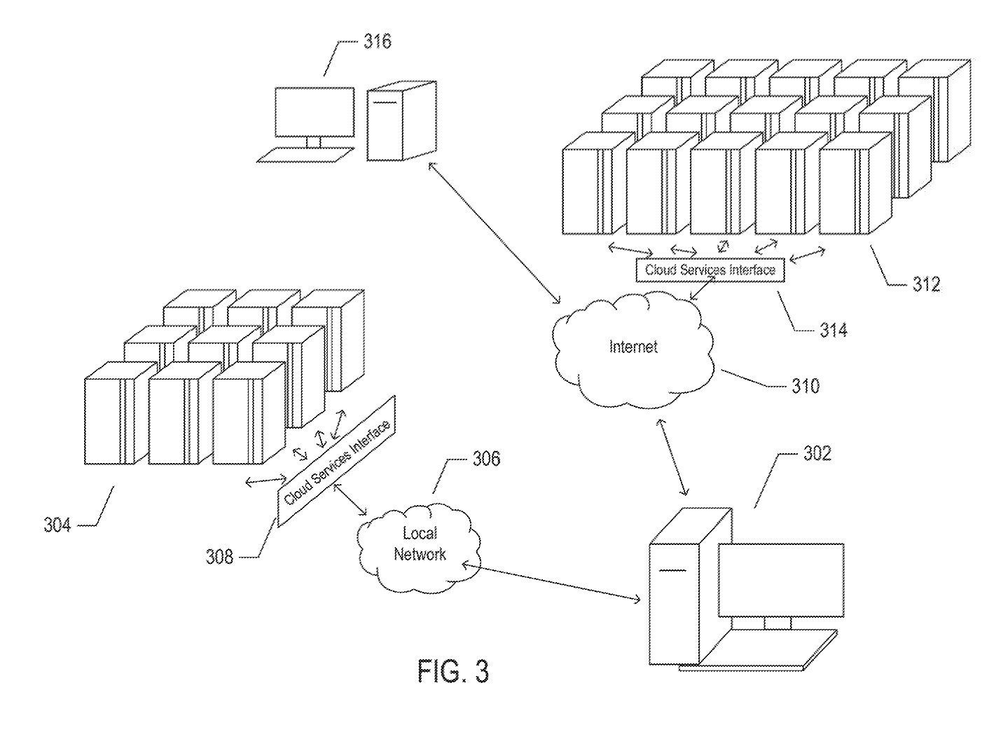

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

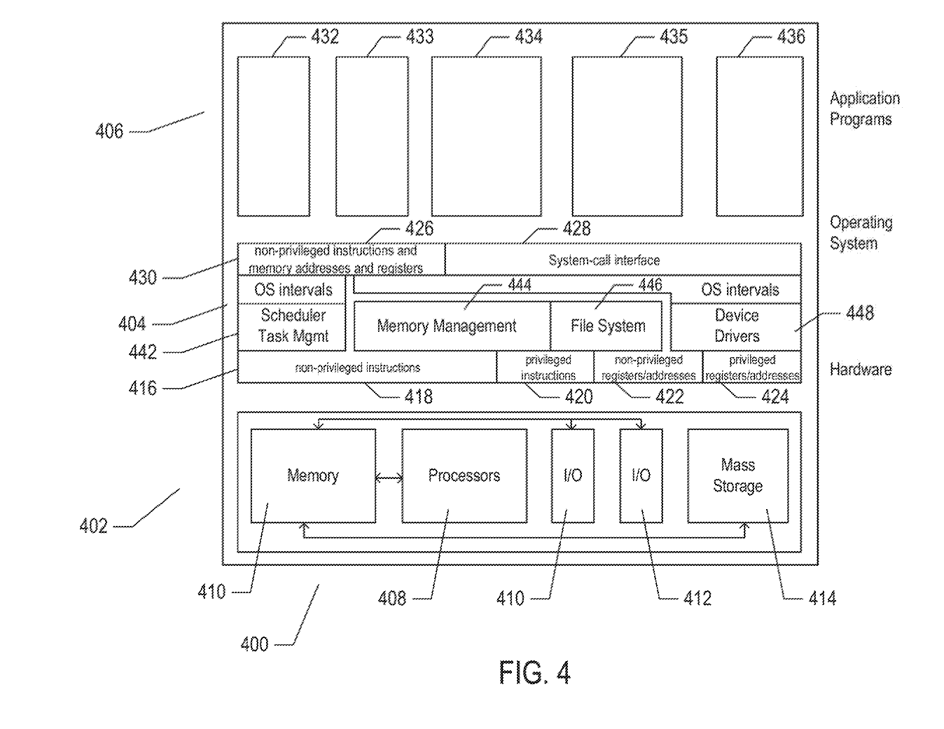

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modem operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

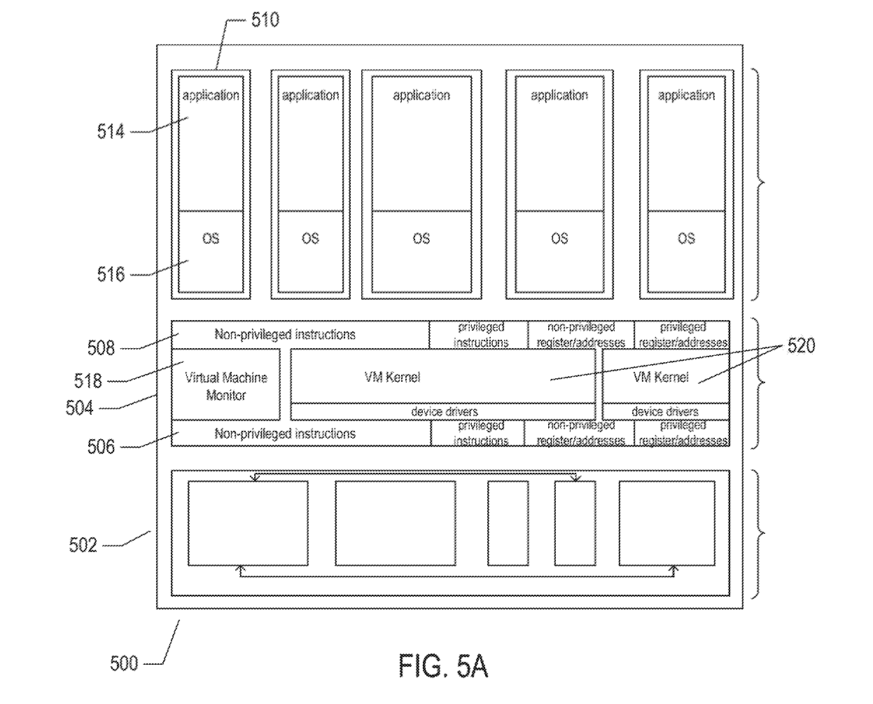

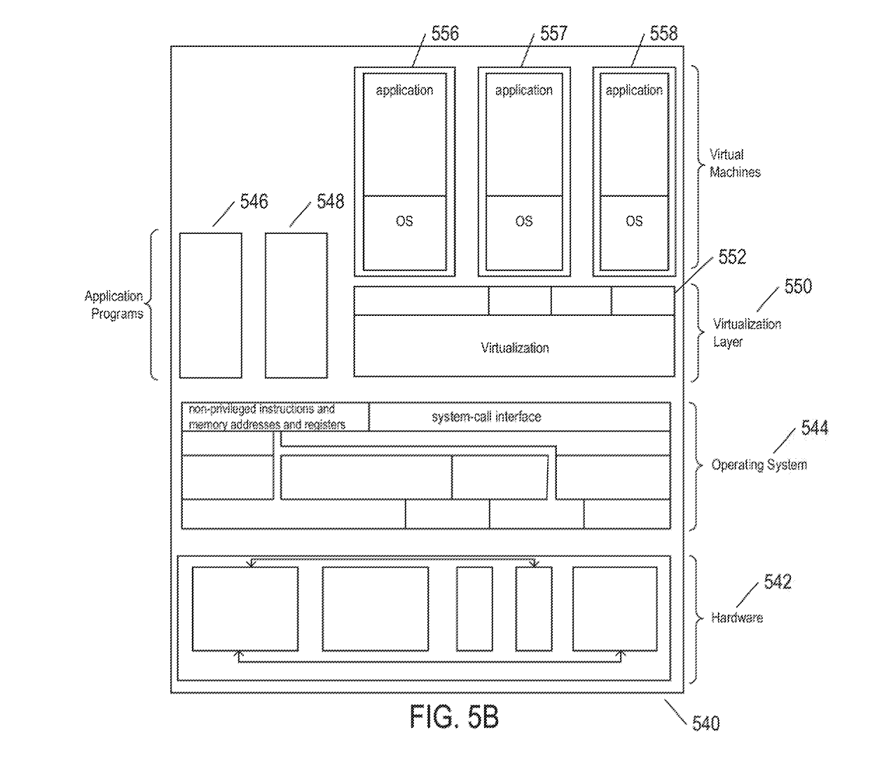

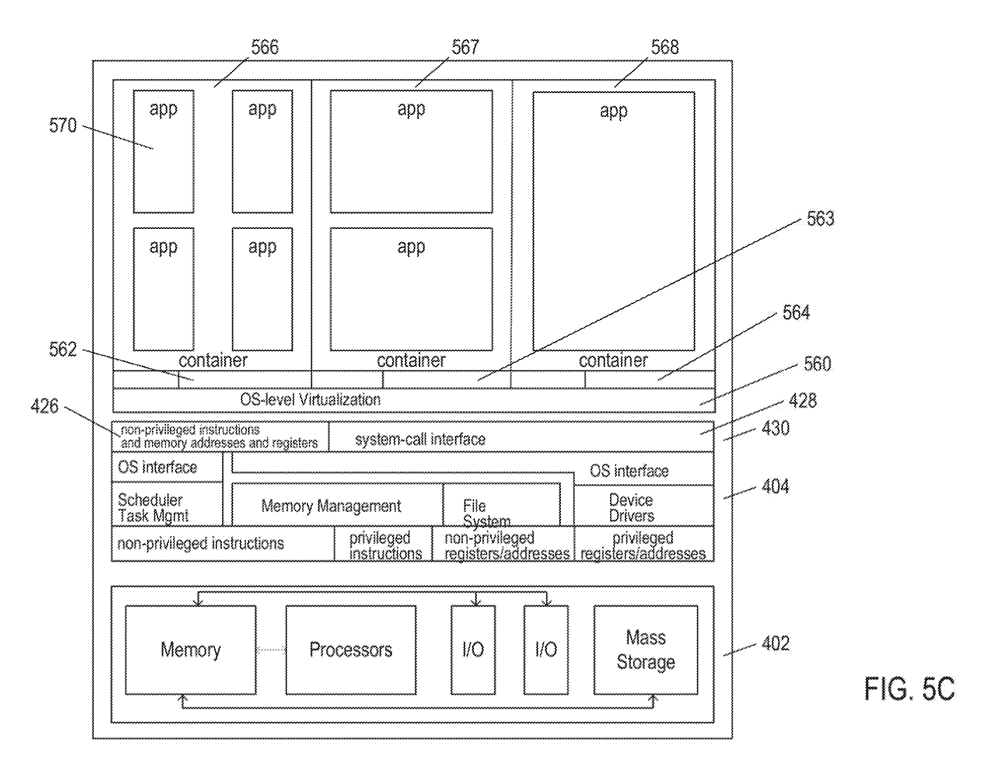

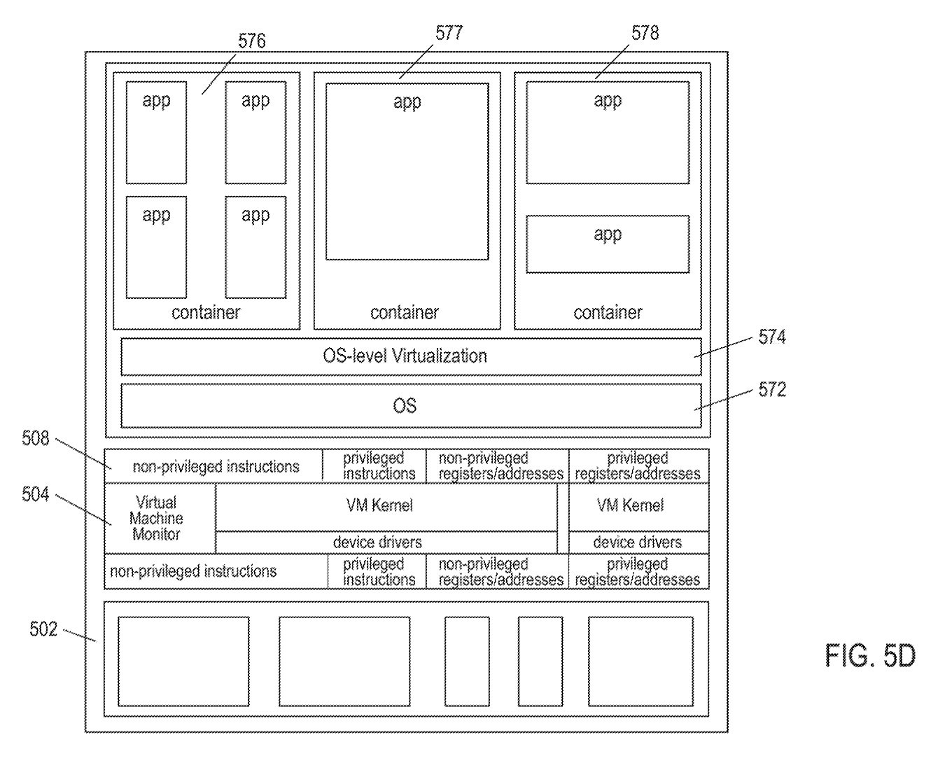

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine, includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a and a hardware-like interface 552, similar to hardware-like interface 508 in FIG. 5A, The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

### Methods and Systems for Testing Electronic Devices, Including Computer Systems

FIG. 6A illustrates a common testing scenario. A first computer system 602 runs a testing application that exchanges requests 604 and responses 606 with a target computer system 608 under test. For example, the target system may execute a database-management application and the testing system 602 may issue a large number of requests containing queries to the database-management application in order to test the accuracy and reliability of query processing, look for various types of bugs and errors in database-management-application query processing, and monitor various query-processing-efficiency metrics to determine average query-execution speeds and bandwidths. As another example, the target computer system may run a large web-page-provision service and the testing system may run testing applications that access large numbers of webpages served by the target system in order to monitor efficiency and to test for various bugs and anomalies.

FIG. 6B illustrates a second common testing scenario. A testing computer system 620 executes a testing application that exchanges requests 622 and responses 624 with a prototype processor-controlled printed circuit board 626 through a communications interface. The printed circuit board supports, as one example, a Non-Volatile-Memory-Express (“NVMe”) solid-state disk drive, and the testing-system application issues large numbers of READ and WRITE commands to the solid-state disk drive through the communications interface in order to determine average and maximum access rates, block-failure rates, and the overheads associated with various bad-block-replacement methods incorporated within the solid-state-disk-drive controller.

There are, of course myriad different types of testing scenarios that may involve a single testing application driving request/response transactions with various devices and systems under test, or may involve many concurrently executing testing applications running on multiple testing computers, or within many virtual testing computers within one or more cloud-computing facilities, that carry out request/response transactions with enormous numbers of target systems and/or target devices under test. Many of these different types of testing scenarios can be understood in terms of a state-transition model or, equivalently, a finite-state machine, that represents the possible states of each target device and target system under test.

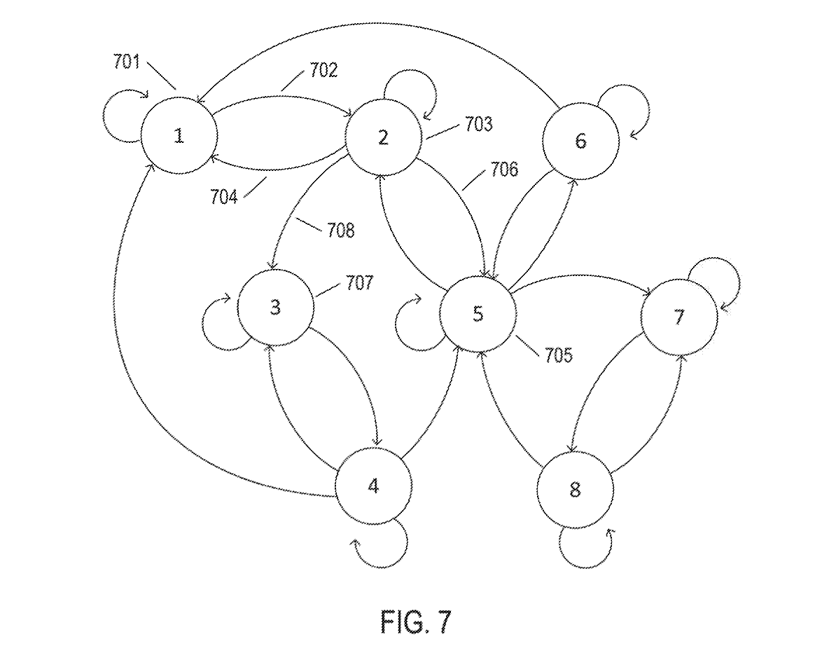

FIG. 7 illustrates a simple state-transition diagram for a target system under test. Each circle, including circle 701, represents a particular state that the target system may occupy and each curved arrow, such as curved arrow 702, represents a transition from a first state to a second state. For example, curved arrow 702 represents a transition from state 701 to state 703. A system under test, or target system, to which the testing system sends requests or commands and from which the testing system receives responses according to a well-defined client/server protocol, is naturally represented by a state-transition model. Most communications protocols are also naturally represented by state-transition models. Many target systems, such as web-server systems, may employ tens, hundreds, thousands, or more processes or threads that are each launched to service particular remote clients through communications-protocol connections. In these target systems, each thread or process may be naturally described by a state-transition model, and the entire system can be described as a set of concurrent state-transition models. Because the states used to model a target system can be somewhat arbitrarily defined, it is generally possible to model most deterministic computational and digital-electronics systems using state-transition models.

in FIG. 7, the first state 701 may represent a waiting-for-a-next-request state of a request-handling thread. When the request-handling thread receives a next request from a remote client, the request-handling thread transitions, via transition 702, to a request-received state 703. Depending on the contents of the request, the request-handling thread may immediately return a response and, in so doing, transition, via transition 704, back to the waiting-for-a-next-request state. Alternatively, the initial request may represent a first step in an ordered sequence of request/response transactions, in which case, after responding to the initial request, the request-handling process waits for a subsequent request in a well-defined sequence of request/response transactions, upon reception of which the request-handling process transitions either to state 705 via transition 706 or to state 707 via transition 708, depending on the contents of the second request. There are, of course, many different ways to express the operational logic of a target system in terms of one or more state-transition models. A particular target system may be modelled using only a few states and state transitions or may be modelled using tens, hundreds, or more states with a correspondingly large number of state transitions, depending on the granularity of the model and the complexity of the target system.

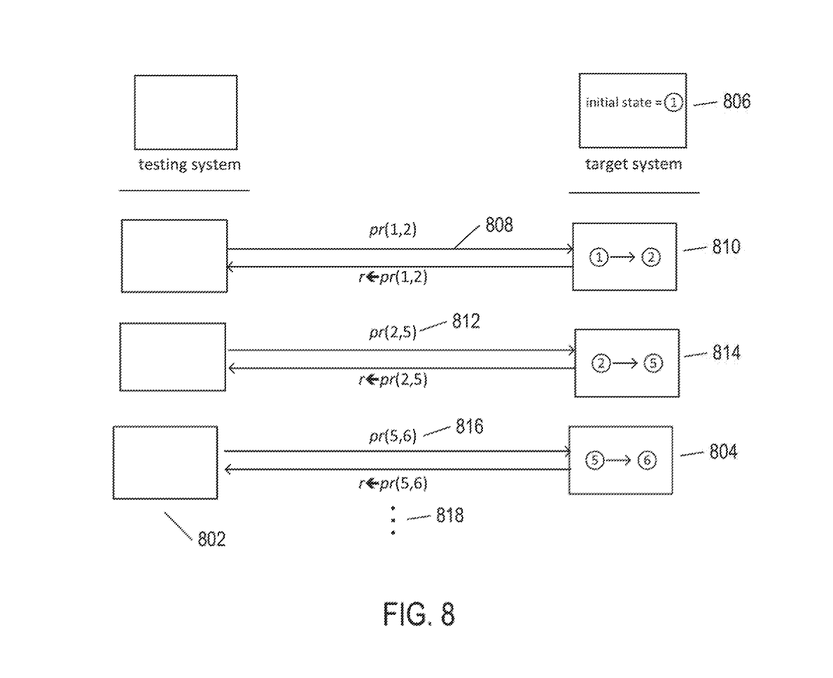

FIG. 8 illustrates a generalized request/response-transaction-based interaction between a testing system and a target system. The testing system is represented by a first column of rectangles 802 and the target system is represented by a second column of rectangles 804. The target system is initially in state 1, represented by rectangle 806. In a first request/response transaction, the testing system issues a request or command 808, represented by the function pr(1,2), which generates a request to induce a transition in the target system from state 1 to state 2. The target system transitions from state 1 to state 2 as a result of receiving the request or command, as indicated by rectangle 810, and returns a response r to the testing system, which is represented as the return value of the function representing the request or command, r=pr(1,2). Thus, the arguments with which the function pr( ) is called specify a desired state transition, the function generates an appropriate request or command that results in the target system transitioning from the first specified state to the second specified state, and the function call returns an indication of the response returned by the target system. The functional representation of request/response transactions initiated by the testing system is a generalized representation of the request/response transactions of many different types of protocols that define communications between testing systems and the target systems and is therefore applicable to a wide variety of request/response-transaction protocols that may be used by a testing system to test various types of target systems. In a next transaction, the testing system issues a request or command 812 that induces a transition in the target system from state 2 to state 5, represented by the function call pr(2,5). The target system transitions to state 5, as represented by rectangle 814, and returns a response represented as the return value r of the function call, r=pr(2,5). A third request/response transaction is represented by the function call 816 pr(5,6). Ellipses 818 indicate that testing of the target system by the testing system may involve many additional request/response transactions. Note that handling of a particular request or command may not involve returning a response to the testing system, in which case the return value r would have a value indicating that no response was returned. The generalized functional representation of the request/response-transaction protocol along with a state-transition model together provide a basis for generating an arbitrarily long sequence of transactions for testing a target system.

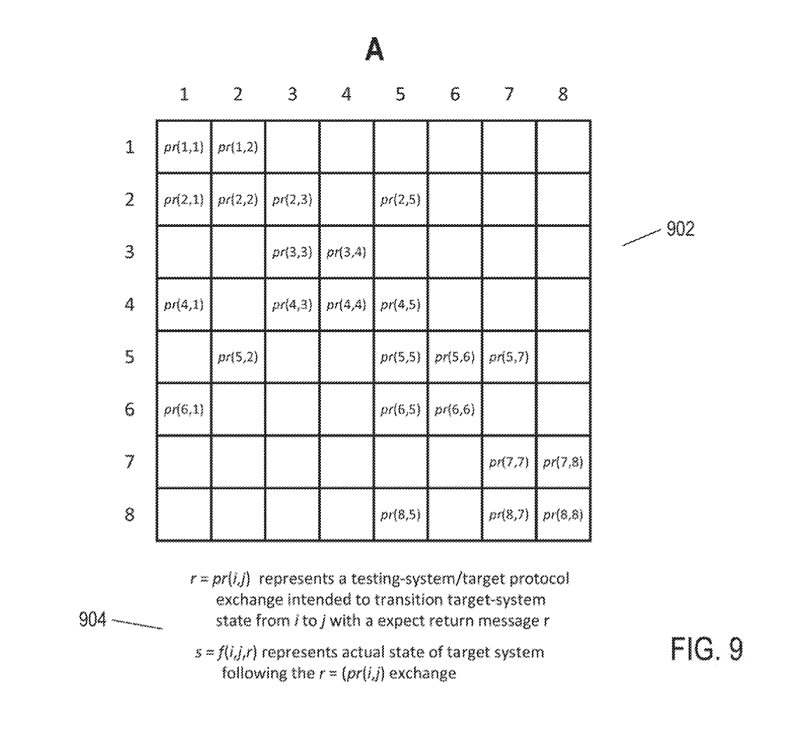

FIG. 9 shows a two-dimensional matrix that represents both the states and state transitions shown in the state-transition model in FIG. 7 as well as the request/response protocol illustrated in FIG. 8 that is represented by the function pr( ). In the two-dimensional matrix. A 902, each cell represents the possibility of a transition between two states. Each cell is described by two indices: (1) a row index; and (2) a column index. The row index represents a current state of the target system and the column index represents a next or subsequent state of the target system. The states are mapped to a sequence of successive integers from 1 to the number of states N. Those cells that include a function call pr(x, y), where x represents the current state and y represents a next or subsequent state, constitute valid state transitions, as represented by curved arrows in the state-transition diagram shown in FIG. 7. As indicated in text 904 at the bottom of FIG. 9, an additional function is used to determine the actual state of the target system following issuance of a request or command by the target system and a response returned by the target system. For example, the expression r=pr(i, j) represents a command or request that is intended to result in a transition of the target system from state i to state j. However, due to an error or to unforeseen circumstances, the target system may either fail to transition to a different state or may transition to an unexpected state and may therefore return a response different from the expected response. Therefore, when the testing system receives a response, the testing system may call a function f( ) to determine the actual state of the target system from the returned response, as indicated by the expression s=f(i, j, r), where s is the actual state to which the target system has transitioned and r is the response returned by the request represented by pr(i, j). When the response returned is not the response expected for the transition from state i to state j, the response is used to determine what state the target system is in. A response may be additionally returned by a local timer when the target system fails to respond within a specified time interval. The Matrix A thus describes both the state-transition diagram shown in FIG. 7 as well as the protocol discussed with reference to FIG. 8.

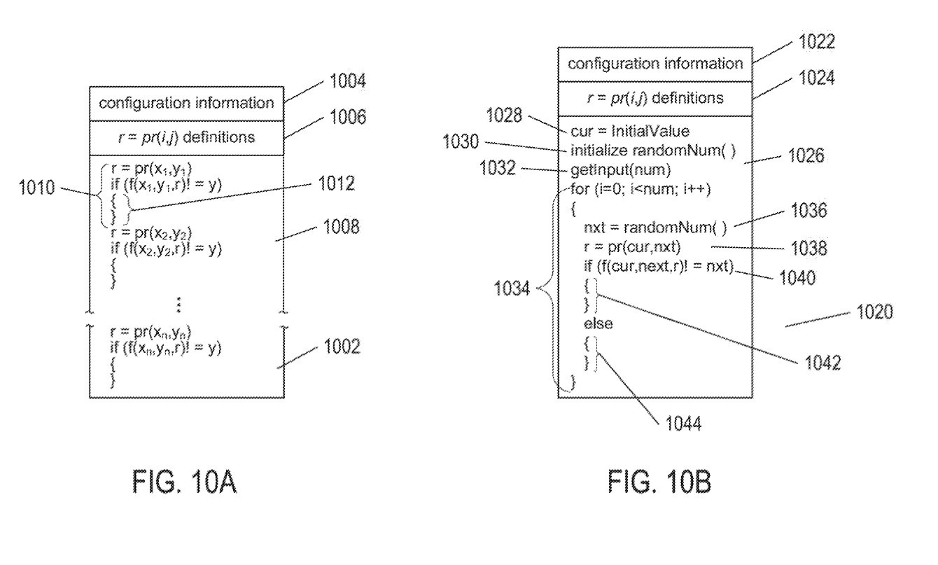

FIGS. 10A-B illustrate two possible approaches to testing based on a request/response-transaction protocol. Both figures show test files that contain test-configuration information and scripts or programs that can be executed to carry out a test. A test file may be consumed by a testing application, with the information contained in the test file controlling the testing application to carry out the desired test. FIG. 10A shows a first test file 1002 that controls a testing application according to a first testing approach. The test file 1002 contains encoded configuration information 1004, definitions for the pr( ) functions 1006 included in a matrix A to describe the states and state transitions of the request/response-transaction-based protocol, and a testing script or program 1008. The configuration information generally contains one or more communications addresses for the target, encoded information specifying the steps needed to connect to the target system for request/response exchanges, an indication of the state of the target, and other parameter values that specify how a test session is to be carried out. The function-definitions section 1006 can be thought of as a description of the request/response-transaction-based protocol logically encapsulated within a matrix A. This section logically includes an implementation of the function pr( ) that handles the possible state transitions. Of course, there are many alternative ways to specify the state-transition model and request/response-transaction protocol that can be employed and encoded within a test file. In the first testing approach, the script includes explicit logic for each request/response transaction. For example, the script statements 1010 call the function pr( ) to induce a particular state transition within the target system, determine the state to which the target system transitioned, using the function f( ), described further below, and, when the state to which the target system transitioned is not the expected state, carries out some type of reporting to an output file in code not shown in FIG. 10A, but that would be included within curly brackets 1012. The script may, of course, also contain various system calls to monitor the time required for each request/response transaction and perhaps other monitoring and results-evaluation code.

This first approach is associated with many deficiencies. First, because it may be necessary to carry out hundreds of thousands, millions, or more request/response transactions in order to test a device or computer system due to the complexity of modern electronic devices and computer systems, the test file may end up containing a huge amount of script code. Such volumes of test code are tedious and time-consuming to create and often very difficult to modify and maintain. For all but the simplest types of testing sessions, this first approach is impractical, at best, and generally infeasible.

FIG. 10B shows a second test file 1020 that represents a second approach to testing. The configuration-information section 1022 and the function-definitions section 1024 are equivalent to those in the first test file 1002 shown in FIG. 10A. However, the script section 1026 is far more compact. A variable cur is set to an initial value to represent the initial state of the target system, in a first statement 1028. Next, a pseudorandom number generator is initialized, in statement 1030. Statement 1032 obtains a desired number of request/response transactions. Then, in each iteration of a for-loop 1034, a next transaction is carried out. First, in statement 1036, a next pseudorandom number is obtained. This is used to attempt to induce a next state transition, in statement 1038. Of course, since the matrix A is generally sparse, a more complex mapping of the pseudorandom number to a valid state transition may need to be carried out. When the resulting state of the target system is not the expected state transition, as determined in the if statement 1040, an error-reporting action is undertaken in statements that are not shown in FIG. 10B, but, if shown, would be located between the curly brackets 1042. Otherwise, expected-case reporting may be carried out in statements between curly brackets 1044. This second approach to testing addresses many of the deficiencies related to the first approach to testing. The test file is relatively compact and the script is both easy to maintain and easy to modify. However, this second approach to testing is associated with many other types of deficiencies. Because the state transitions are selected on a completely stochastic basis, there is no guarantee that two different testing sessions controlled by the test file will test the same functionalities of the target system. In certain complex protocols, it could well be the case that a purely stochastic transaction selection would end up testing only a very small portion of the possible state transitions, and it is very likely that the patterns and types of transactions would differ greatly from testing session to testing session. Thus, the second testing approach is essentially nondeterministic, and therefore not repeatable, and is not guaranteed to comprehensively test the target system. Of course, since the pseudorandom number generator is not random, the testing method cannot be strictly characterized as nondeterministic, but practically, it is nondeterministic, since there an enormous number of possible transaction sequences even for a relatively small number of state transitions.

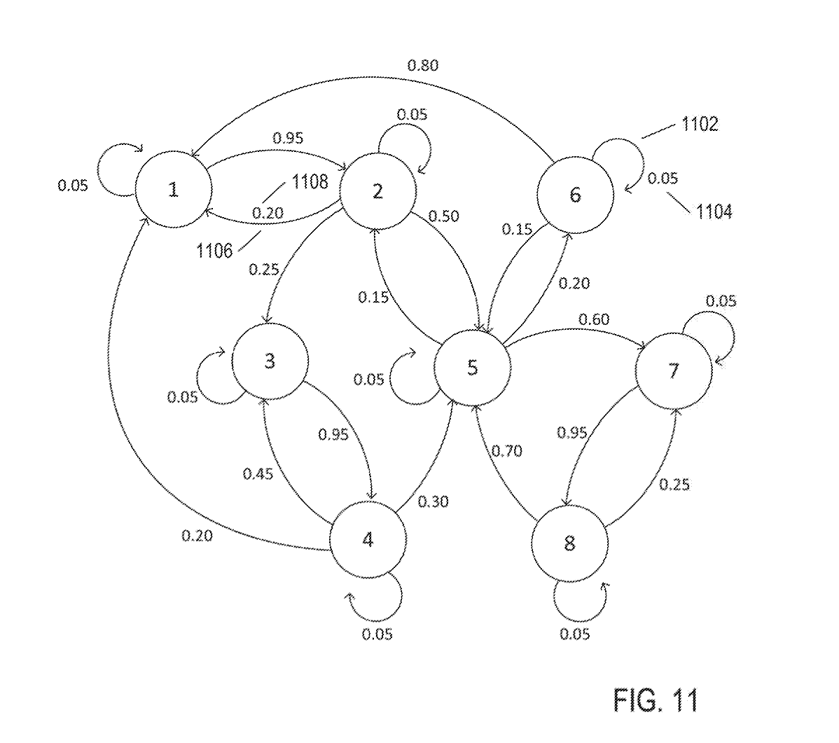

FIG. 11 illustrates assignment of probabilities to the state-transition diagram shown in FIG. 7 to create the basis for a Markov process. As shown in FIG. 11, each curved arrow representing a state transition is associated with a probability value between 0.0 and 1.0. The sum of the probability values associated with the outgoing transitions or outgoing curved arrows from each state is 1.0. Thus, there is a 100% probability that one of the outgoing arrows will be selected as a proposed state transition at each step of a stochastic Markov process carried out using the state-transition model with state-transition probabilities shown in FIG. 11. A Markov process is a stochastic process in which the selection of a next state transition at each step of the process depends only on the current state of the system, and not on the history of transitions leading up to the current state. For state-transition models of most computational processes, including most communications protocols, there is a small probability that no state transition will occur at any given step. The circular curved arrows that curve back to the states from which they emanate, such as circular curved arrow 1102, represent no-state-change transitions. For example, a communications message may be garbled in transmission, as a result of which it is simply ignored by the receiving target system. In the Markov process represented in FIG. 11, the no-state-change transitions are each associated with a 5% probability, such as probability 1104 that annotates transition 1102. A Markov process is carried out by starting out an initial state and taking a number of steps n. At each step, a pseudorandom number between 0 and 1 is generated, and the generated pseudorandom number is used, as further described below, to choose one of the transitions leading from the current state to a next day. The Markov process is essentially a random walk from one state to another along the state transitions of a state-transition model.

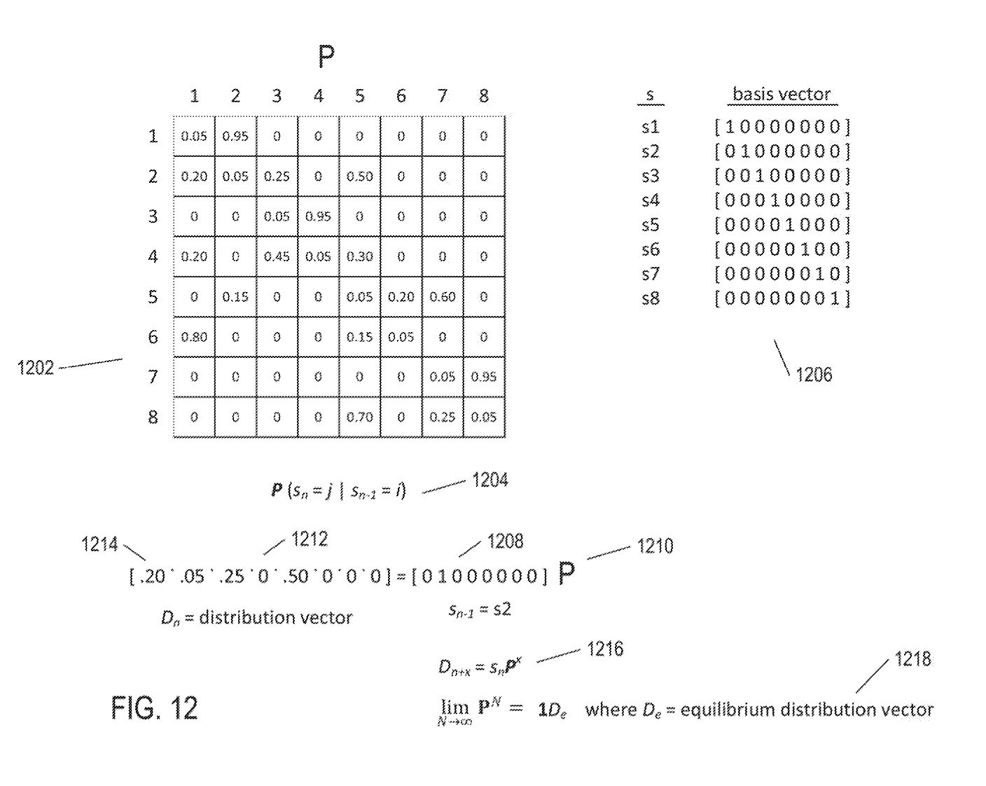

FIG. 12 illustrates a matrix encoding of the representation of the Markov process shown in FIG. 11. A matrix P 1202 stores all of the state-transition probabilities in a manner similar to storing the pr( ) function definitions in the matrix A, discussed above with reference to FIG. 9. The probability contained in each cell of matrix P is the probability that, when the target system is in a state i, where i is the row index, the target system will transition to the state j, where j is the column index, as represented by the expression 1204. Each state can be represented by a row vector, as shown by the column of row vectors corresponding to states 1206 in FIG. 12. The row vectors corresponding to the states form a basis for a vector space of dimension equal to the number of states. Multiplication of the basis vector corresponding to a current state 1208 by the matrix P 1210 generates a distribution vector 1212 with components equal to the probabilities of a transition from the current state to each of the states in the state-transition model.

In FIG. 12, the row vector 1208 represents the state 2 and the distribution vector 1212 therefore includes all of the state-transition probabilities for state transitions leading from state 2 to the 8 states of the target system, including state 2. For example, the transition from state 2 to state 1 (1106 in FIG. 11) is associated with a probability of 0.2 (1108 in FIG. 11), which is the value of the first component 1214 in the distribution vector 1212. As shown by expression 1216, the distribution vector for a state x steps in the future from a state n is computed by raising the matrix P to the power x, which involves x−1 matrix multiplications, and then multiplying the basis vector corresponding to state n by the matrix P^{x}. When matrix P has certain properties, the limit of P^{N} as N increases to infinity is a matrix in which all of the rows are identical and are equal to an equilibrium state-probability distribution vector that contains the probabilities of the target system being is in each of the various different states at any given step. This is shown in the expression 1218 in FIG. 12, with the notation 1Dₑ indicating the outer product of a column vector 1, with each component equal to 1, and the equilibrium distribution vector De.

There are a number of different sets of properties that guarantee an equilibrium distribution of state probabilities. One set of properties that guarantees this behavior is: (1) there is a path of state transitions leading from any given state to any other state; and (2) there is no state i associated with a period of k steps that necessarily results in a return to state i, where k is greater than 1. In other words, the state-transition-diagram-like representation of the Markov process it is both irreducible and aperiodic. Another set of properties that guarantees an equilibrium state-probability distribution for a Markov process represented by a state-transition model is: (1) when the target system is in the state i, the Markov process is guaranteed to return to state i after a finite number of steps, for all states; (2) the state-transition-diagram-like representation of the Markov process is irreducible; and (3) the state-transition-diagram-like representation of the Markov process is balanced, which means that the product of the probability of the state i and the probability of transitioning from the state i to the state j is equal to the probability of the state j times the probability of transitioning from the state j to the state i, for all pairs of states i and j. What this means, practically, is that, for any state-transition-diagram-like representation of a Markov process with one of the above sets of characteristics, or other sets of certain characteristics, the Markov process it is stochastic over local periods of time, but deterministic over long periods of time, in the sense that the probability of the target system residing in any particular state at any given step is an equilibrium probability that is a characteristic of the Markov process. Thus, for a large number of steps, a testing application that carries out the generation of request/response transactions by Markov process associated with an equilibrium distribution of state probabilities, also referred to as a stationary distribution of state probabilities, is deterministic with respect to the fraction of the total number of steps in which the target system occupies each particular state during testing, even though the probabilities that particular states will be occupied over a small period of time are essentially nondeterministic and the actual sequence of state transitions that occur during testing is also nondeterministic.

When a Markov process is associated with a stationary state-probability distribution, by having, the above-discuss properties that guarantee a stationary state-probability distribution as the number of states visited during a Markov process increases, the Markov process provides for locally stochastic, but globally deterministic behavior. As discussed further below, a test designer can specify the state-transition probabilities for a Markov process with a stationary state-probability distribution, in a first approach. A random walk of the state-transition model generates a huge number of different state-transition paths, for most such Markov processes, with a guarantee that the fractions of individual specific state transitions produced by testing correspond to the products of probabilities associated with the state transitions and the equilibrium probabilities of the states. Alternatively, the test designer can specify a desired distribution of state probabilities, and use a Metropolis-Hastings approach to dynamically adjust state-transition probabilities so that, globally, the specified distribution of state probabilities occurs during the Markov process. Unlike the approach to testing discussed above with reference to FIG. 10B, a testing approach based on a Markov process with a stationary state-probability distribution provides both locally stochastic exploration of many different state-transition paths and a significant level of determinism and repeatability due to a global equilibrium state-probability-distribution.

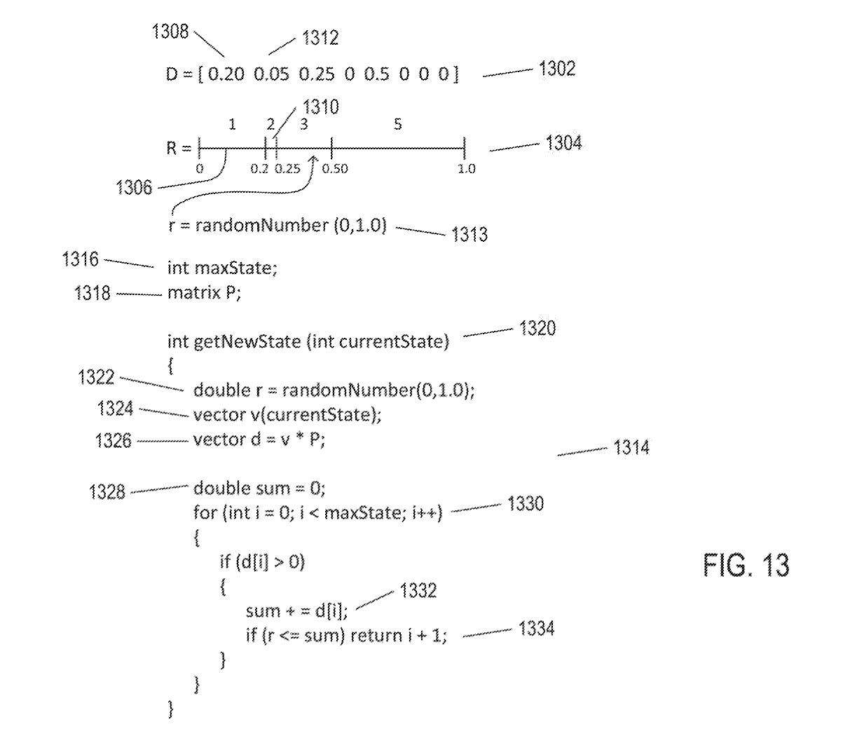

FIG. 13 illustrates a method for choosing a next state during a random walk of a state-transition model. This method is the basis for a first disclosed probabilistic testing method in which state-transition probabilities are specified for a Markov process with a stationary state-probability distribution. As discussed above with reference to FIG. 12, the Markov process can be represented by a matrix P that includes probabilities for all possible state transitions. As discussed above with reference to FIG. 12, the basis vector representing a particular state is multiplied by the matrix P to generate a distribution vector D. A first step in choosing a next state is to generate the distribution vector D for the current state. In the example shown in FIG. 13, a distribution vector D 1302 is generated for a current state of 2 with respect to the state-transition model shown in FIG. 11. In a second step, the probability values for the different states in the distribution vector are used to generate a mapping of the state-probability distribution to a segment of the real number line 1304 from 0.0 to 1.0. The mapping associates each state having a non-zero probability in the distribution vector to a corresponding subsegment within the segment 1304 of the real number line. The lengths of the subsegments are proportional to the probabilities of the associated states. In the example shown in FIG. 13, a first segment 1306 within the real-number-line segment 1304 has a length 0.2 which is equal to the probability 1308 for the first state encoded as a first component of the distribution vector 1302. The line segment 1310 for the second state has a length of 0.05, equal to the probability 1312 associated with the second state in the distribution vector. In a third step 1313, a pseudorandom number generator is used to generate a pseudorandom number r in the range [0.0, 1.0]. Finally, in fourth step, the pseudorandom number r is mapped to the real-number-line segment 1304, and the state associated with the segment to which the pseudorandom number r maps is chosen as the next state to which to transition from the current state.

This process is shown in pseudocode 1314 in FIG. 13. A variable maxState 1316 contains the highest-numbered state, with the assumption that the states are consecutively numbered starting with the number 1 and ending with maxState. The matrix P 1318, like the variable maxState, is declared as a global variable for the pseudocode routine. The routine getNewState 1326 receives an it to argument currentState representing the current state of the target system and returns an integer representing the state to which to transition to in the next step of the Markov process. A variable r is set to a pseudorandom number in the range [0.1] in line 1322. A basis vector v is initialized to represent the current state, in line 1324. A distribution vector d is generated by multiplying the vector v by the matrix P, in line 1326. A variable sum is initialized to 0, in line 1328. In a for-loop that begins with statement 1330, the variable sum is iteratively incremented by a next probability extracted from the distribution vector d, in statement 1332, until the variable r has a value less than or equal to the value stored in the variable sum, in which case a state equal to the sum of the iteration variable i and 1 is returned, in statement 1334. The method encoded in the function getNewState is equivalent to the method depicted at the top of FIG. 13. This method for choosing a next state is repeatedly carried out in order to conduct a random walk of a state-transition model, with each state transition induced by a particular request/response transaction, in the first disclosed testing method, selected from the matrix A.

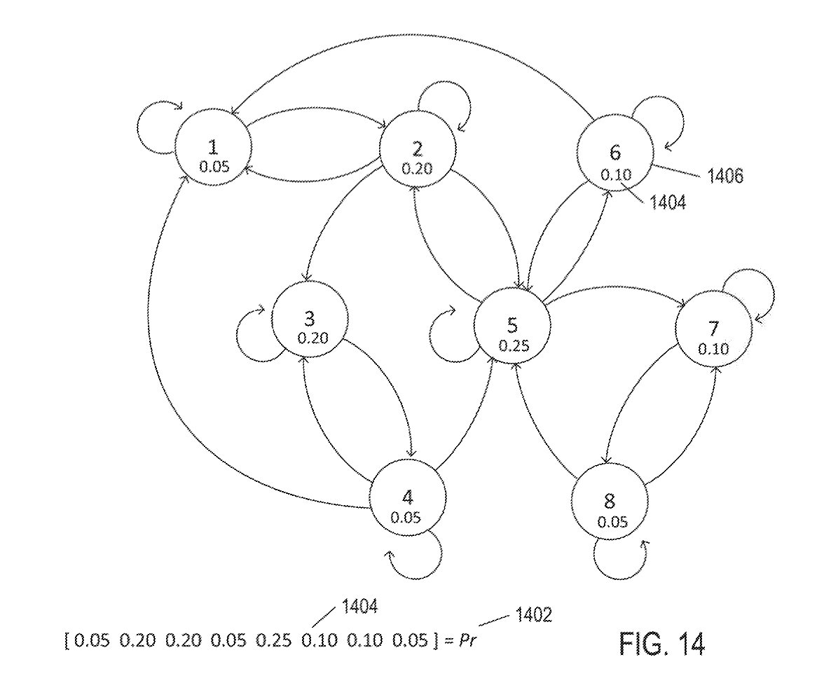

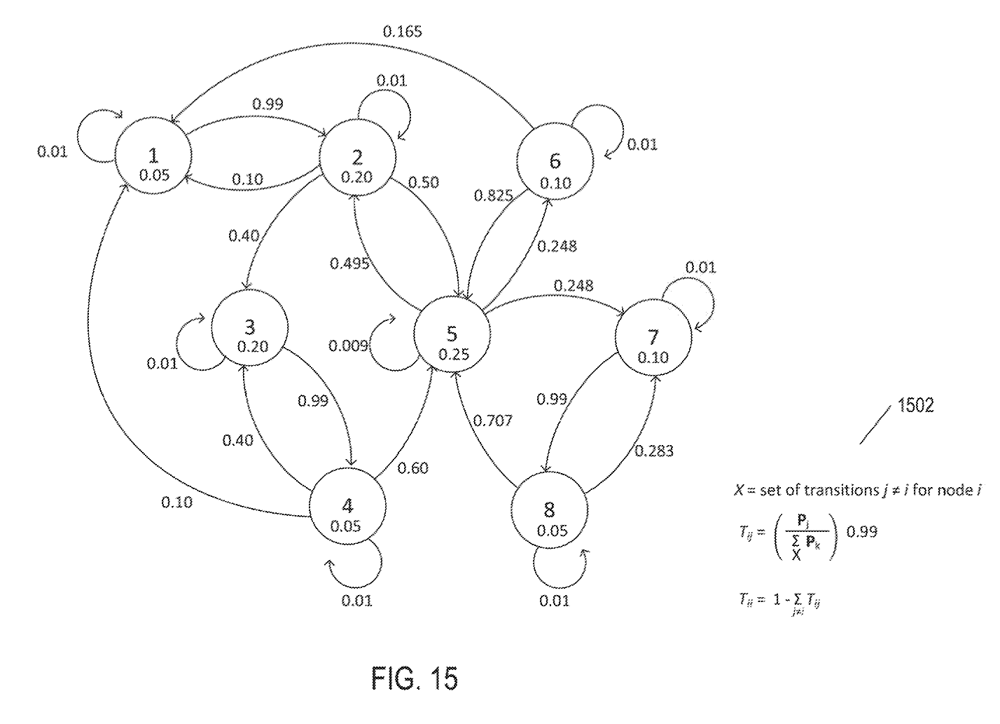

FIGS. 14-16 illustrate features of a second disclosed probabilistic testing method. In this second testing method, as shown in FIG. 14, the probabilities of the states are specified as a state-probabilities vector Pr 1402. FIG. 14 shows the state-transition diagram previously shown in FIG. 7 with the state probabilities included in the circular representations of the states, such as the state probability 0.1 (1404) included in the representation of state 6 1406). Then, as shown in FIG. 15, initial probabilities are assigned to each of the state transitions. One method for assigning initial state-transition probabilities is shown by expressions 1502 in the lower right-hand side of FIG. 15. For each state, a set of transitions from that state to another state, X, is considered. For each transition in the set of transitions X for state i, the transition probability Tij for transition from the state i to the target state j is computed as a product of the ratio of the state probability for state j to the sum of the state probabilities for all of the target states corresponding to the transitions in the set of transitions X and the number 0.99. The probability for the transition from state i to itself is set to the sum of the state-transition probabilities for the transitions in the set X subtracted from 1.0, which is approximately 0.01. Any of various alternative methods can be used to set the initial probabilities for the state transitions. The second testing method is generally relatively insensitive to the initially assigned probabilities, since, as discussed below, a Metropolis-Hastings method is used to dynamically adjust the state-transition probabilities in order to achieve an equilibrium state-probability distribution equal to the specified state-probability distribution Pr.

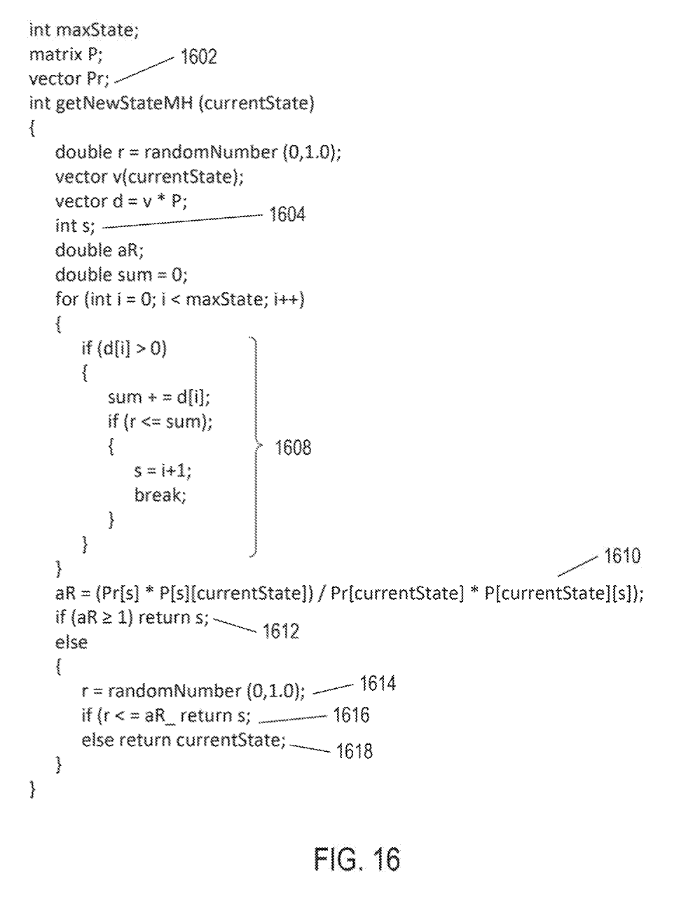

FIG. 16 shows a second implementation of the function for computing a next state for a next step of a Markov process, getNewStateMH( ). The second implementation has many similarities with the first implementation, discussed above with reference to FIG. 13. However, additional logic is included to implement the Metropolis-Hastings method. A global vector Pr is declared, in statement 1602. This vector represents specified state probabilities, as illustrated by vector 1402 shown in FIG. 14. The variable s is declared in statement 1604 to contain a computed next state. The variable aR, declared in statement 1606, stores an acceptance-ratio value. The for-loop 1608 computes the next state in the same was as the next state is computed in the first implementation shown in FIG. 13. Then, in statement 1610, an acceptance ratio for the computed next state s is computed as the probability of state s multiplied by the state-transition probability for transitioning from state s to the current state divided by the probability of the current state multiplied by the state transition probability for transitioning from the current state to state s. When the acceptance ratio is greater than or equal to 1, the computed state s is returned as the next state in statement 1612. Otherwise, a second pseudorandom number is generated, in statement 1614, and is used to determine whether to return computed state s, in statement 1616, or return of the current state, in statement 1618. Essentially, state s is selected with a probability equal to the acceptance ratio when the acceptance ratio is less than 1. The Metropolis-Hastings method ensures that the Markov process is balanced. Because each state is associated with a state transition back to itself, or, in other words, a no-state-change transition, and because the no-state-change transitions generally have non-zero probabilities, the Markov process is guaranteed to be aperiodic. The matrix P also needs to represent an irreducible state-transition model in which it is possible to reach any state from a given initial state. As a result, the Markov process is associated with a stationary state-probability distribution, as discussed above with reference to FIG. 12.

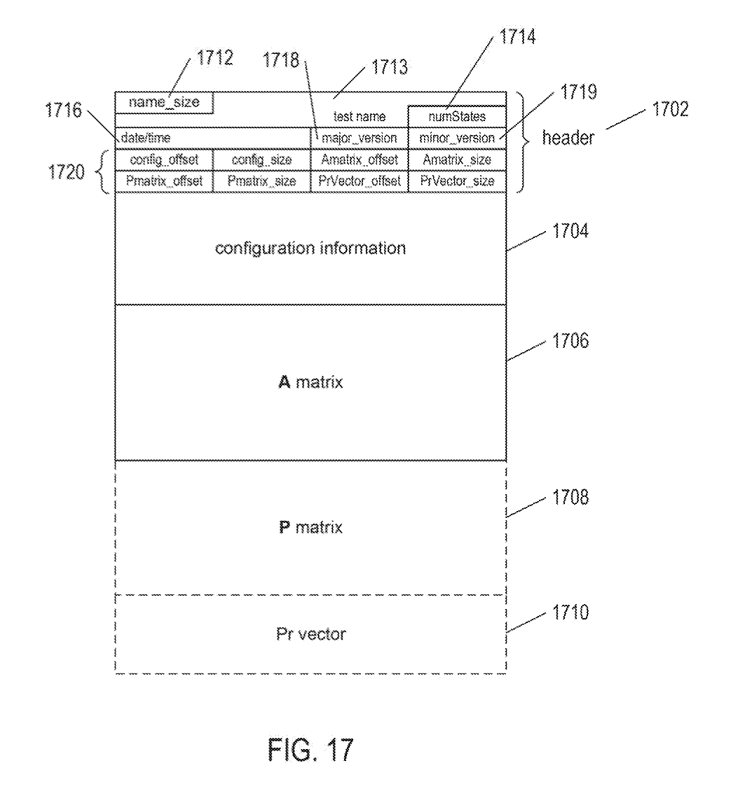

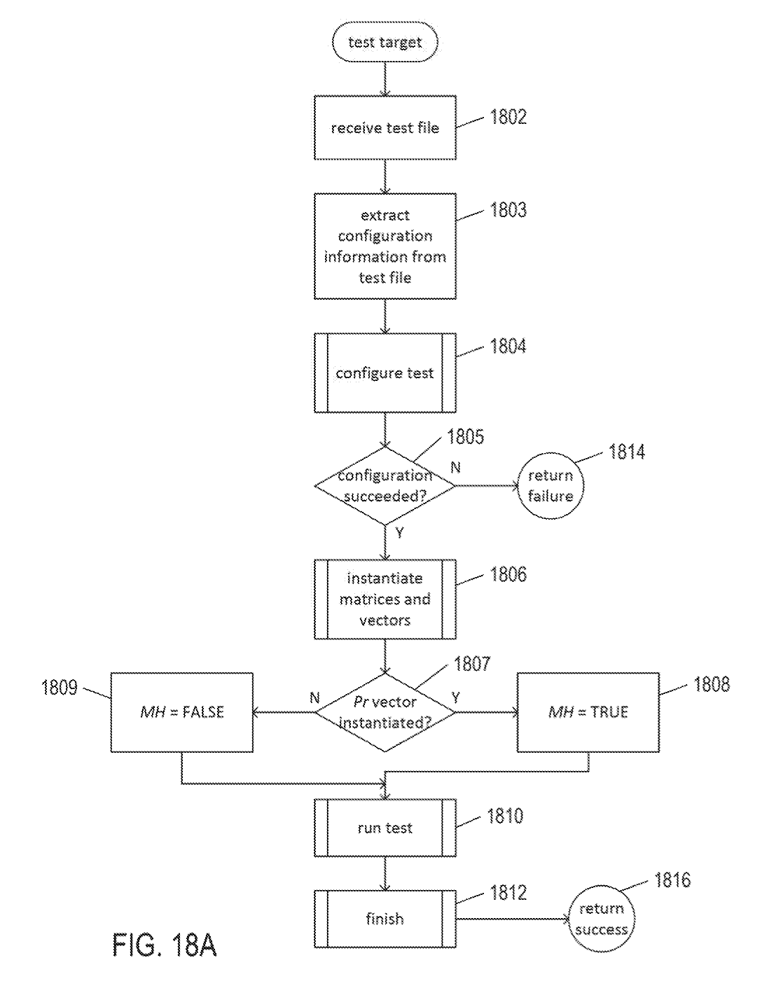

FIG. 17 illustrates a test file, similar to the test files previously described with reference to FIGS. 10A-B, used to encode the two different types of probabilistic tests that represent examples of the currently disclosed probabilistic testing methods. The test file includes a header section 1702, a configuration-information section 1704, an A-matrix section 1706, discussed above with reference to FIG. 9, a P-matrix section 1708, discussed above with reference to FIG. 12, and a section that contains a Pr state-probability distribution vector 1710, discussed above with reference to FIG. 14. The header section includes numerous fields that specify a test name 1712-1713, the number of states in the Markov process 1714, a date and time indicating the date and time of the last modification to the test file 1716, major and minor version numbers 1718-1719, and sizes and offsets of each of the non-header sections of the test file 1720. The information contained in the test file is used by a testing application program to run a request/response-transaction-based test for which the load is generated by a Markov process.

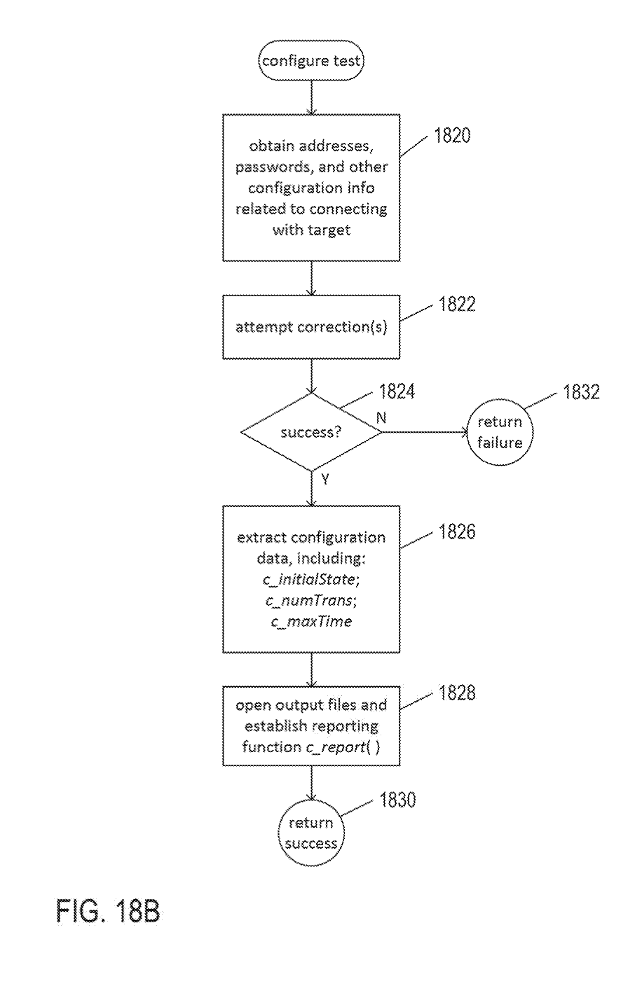

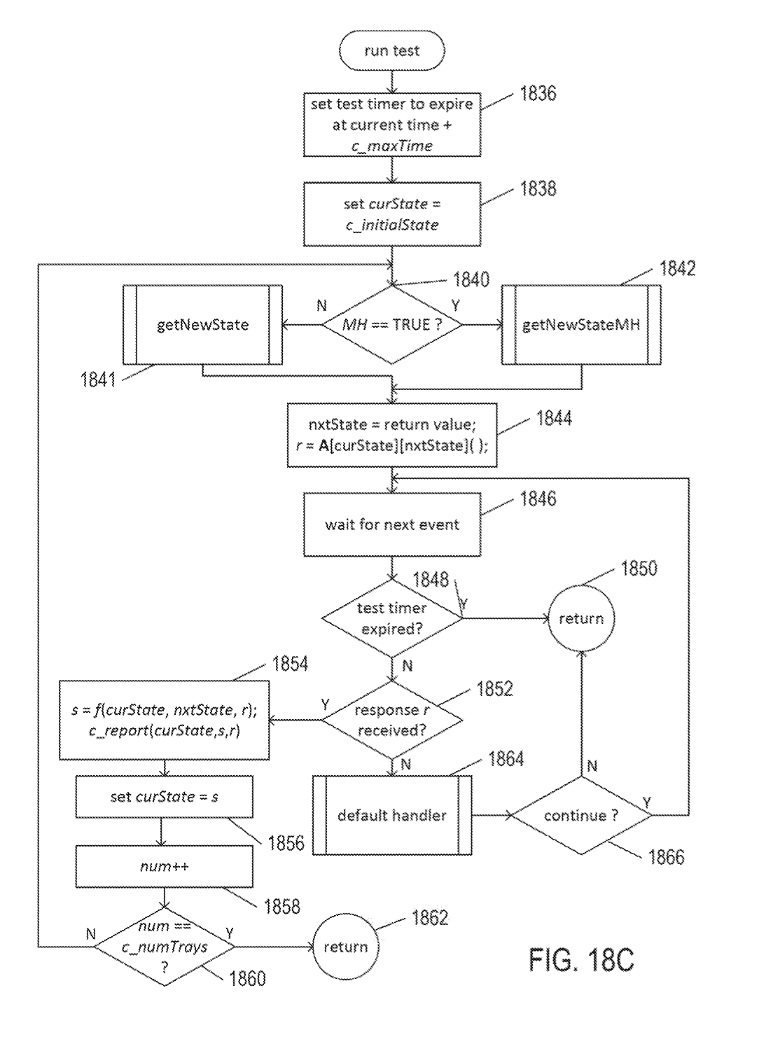

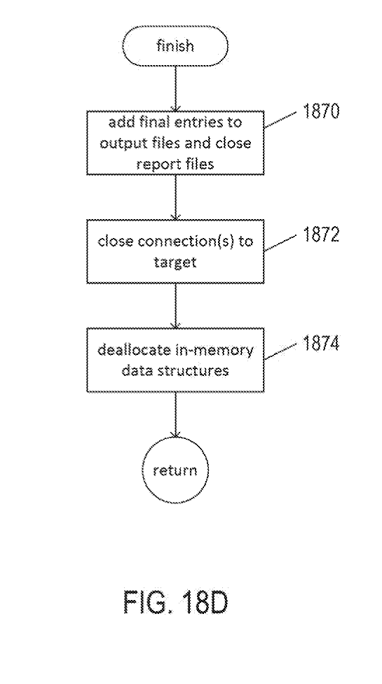

FIGS. 18 A-D show control-flow diagrams that illustrate one implementation of a testing application that uses a test file, such as the test file illustrated in FIG. 17, to run a test specified by the information contained in the test file. FIG. 18 A shows a control-flow diagram for a routine “test target,” which carries out a specified testing session using a Markov process to generate the request/response transactions. In step 1802, the routine “test target” receives a test file. In step 1803, the routine “test target” extracts configuration information from the test file and then, in step 1804, calls the routine “configure test” to configure a testing session based on the extracted configuration information. When the routine “configure test” returns an indication of successful configuration, as determined in step 1805, the routine “test target” calls a routine “instantiate matrices and vectors,” in step 1806, to prepare in-memory representations of the A and P matrices and, when it is included in the test file, the Pr vector. When a Pr vector is specified in the test file, as determined in step 1807, a Boolean variable, MH is set to TRUE, in step 1808, and is otherwise set to FALSE, in step 1809. The Boolean variable MH indicates whether or not to use the Metropolis-Hastings method. In step 1810, the routine “test target” calls the routine “run test” to carry out a sequence of request/response transactions generated via the Markov process. Finally, in step 1812, the routine “test target” calls the routine “finish” to close output files and deallocate data structures from memory. The routine “instantiate matrices and vectors,” called in step 1806, is not further described, below, since instantiation of matrices and vectors from information contained in the test file depends on the particular format of the information encoded in the test file and because instantiation of matrices and vectors from an input file is straightforward. When the configuration does not succeed, as determined in step 1805, the routine “test target” returns a failure indication, in step 1814. Otherwise, when the test finishes, the routine “test target” returns a success indication, in step 1816.

FIG. 18B provides a control-flow diagram for the routine “configure test,” called in step 1804 of FIG. 18 A. In step 1820, the routine “configure test” obtains addresses, passwords, and other configuration information needed to configure a test session with the target system from the configuration information extracted from the test file in step 1803 of FIG. 18A. In step 1822, the routine “configure test” attempts to establish one or more communications connections with the test system, as specified in the configuration information. When the test application has successfully established one or more connections to the test system, as determined in step 1824, the routine “configure test” extracts additional configuration data from the test file, including an initial state for the target system, a number of request/response transactions to carry out during the test, and a maximum time for running the test session, which are stored in the variables c_initialState, c_numTrans, and c_maxTime, in step 1826. In step 1828, the routine “configure test” opens one or more output files to which test results are reported by the test application, specified in the configuration section of the test file, and prepares a reporting function c_report( ) that is called during the test session by the test application to report results to the output files. Of course, in certain implementations, the results may be processed in real time in addition to, or instead of, output to output files. In step 1830, the routine “configure test” returns an indication of successful configuration. When the routine “configure test” is unable to establish the specified communications connections to the target system, as determined in in step 1824, the routine “configure test” returns a failure indication, in step 1832.

FIG. 18C provides a control-flow diagram for the routine “run test,” called in step 1810 of FIG. 18A. In step 1836, the routine “run test” sets a timer to expire at a future point in time equal to the current time plus the value in the variable c_maxTime. This ensures that the test session ends once it has run for a specified maximum amount of time. In step 1838, the routine “run test” sets a variable curState to the value stored in the variable c_initialState and sets a variable num to 0. When the Boolean variable MH is TRUE, as determined in step 1840, the routine getNewStateMH is called, in step 1842, to determine a next state transition. Otherwise, the routine getNewState is called, in step 1841, to determine the next state transition. In step 1844, the variable nxtState is set to the return value returned by one of the two routines getNextStateMH and getNextState. Then, the pr( ) function stored in the cell of matrix A corresponding to a transition from the current state to the next state is called to effect the state transition. In step 1846, the routine “run test” waits for a next event to occur. When the next occurring event is the expiration of the test timer, as determined in step 1848, the routine “run test” returns, in step 1850. Otherwise, when the next occurring event is a response to the request sent in step 1844, as determined in step 1852, the state of the test system is determined, in step 1854, based on the value returned by the pr( ) function called in step 1844, using the function f( ), discussed above with reference to FIG. 9. The function c_report ( ) is called to report the result of the request/response transaction initiated in step 1844. Of course, the function c_report may report only certain types of errors or anomalies, and may otherwise compile statistics for the returned responses. The function c_report ( ) is intended as a generalized result-reporting function that can have many different implementations and report many different types of test results. In step 1856, the variable curState is set to the determined state of the test system. In step 1858, the variable num is incremented. When the value in the variable num is not equal to the value stored in the variable c_numTrans, as determined in step 1860, control returns to step 1840 to carry out a next step of the Markov process. Otherwise, the routine “run test” returns, in step 1862. When the next occurring event is not a response to the request, as determined in step 1852, a default handler is called, in step 1864, to handle rare and unexpected events. When the default handler returns an indication to continue with the test session, as determined in step 1866, control flows to step 1846, where the routine “run test” waits for a next event. Otherwise, the routine “run test” returns, in step 1850.

FIG. 18D provides a control-flow diagram for the routine “finish,” called in step 1812 of FIG. 18A. In step 1870, the routine “finish” adds final entries to the output files and closes the output files. In step 1862, the routine “finish” closes any open connections to the target system. In step 1864, the routine “finish” deallocates in-memory data structures, including the in-memory instantiations of the matrices P and A.

Thus, as illustrated in FIGS. 18 A-D, the test application carries out a test session based on the information stored in a test file passed to the test application. Configuration information can either specify the state-transition probabilities for a Markov process or can specify an equilibrium state-probability distribution for the Markov process. The matrix P supplied in the test file represents an irreducible state-transition model in which any state can be reached from any other state by a finite number of steps. Of course, in many embodiments, multiple test sessions may be carried out by one or more test applications executing within a test system. For example, a test application may asynchronously large multiple instances of the “test target” routine.

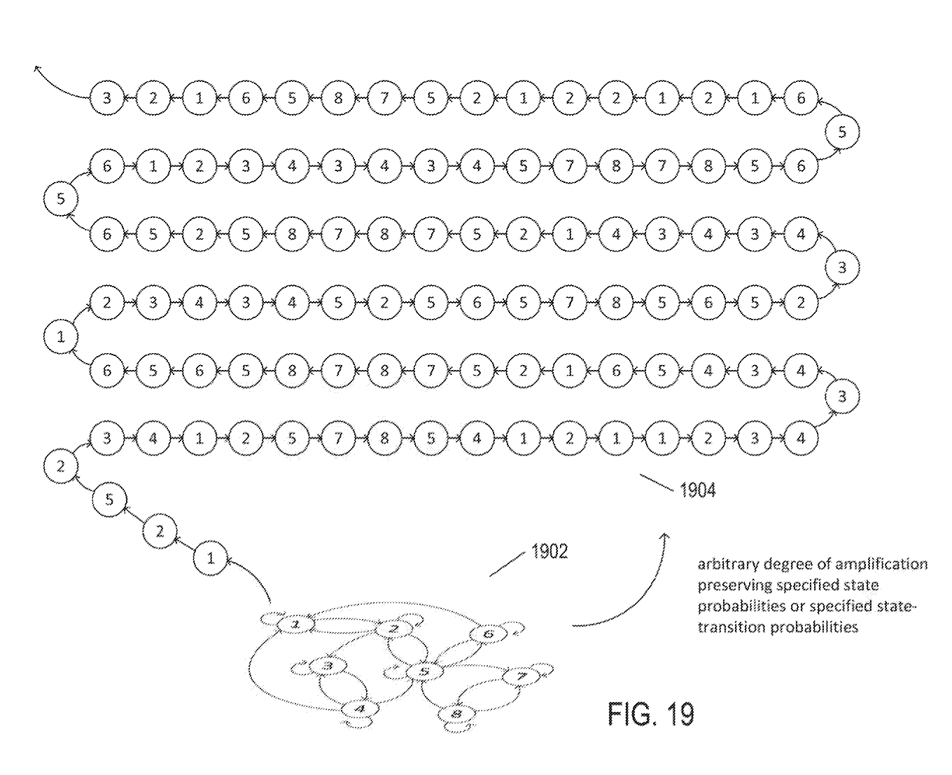

FIG. 19 illustrates the nature of probabilistic load generation for testing purposes. As shown in FIG. 19, a concise specification of a Markov process 1902, containing a relatively small number of states that correspond to a request/response transaction protocol, leads to an arbitrarily long sequence of state transitions 1904 effected by carrying out request/response transactions between the testing system and the target system in accordance with a random walk of a state-transition model. As discussed above, while the sequence of state transitions induced in the target system is locally stochastic, the sequence of state transitions is globally deterministic, in the sense that the state-the probability equilibrium distribution is constant or nearly constant over multiple test sessions.

Although the present invention has been described in terms of particular embodiments, it is not intended that the invention be limited to these embodiments. Modifications within the spirit of the invention will be apparent to those skilled in the art. For example, a variety of different methods can be used to assign initial state-transition probabilities to a Markov process for testing sessions specified to have particular state-probability equilibrium distributions. A Markov process can be used for probabilistic load generation for a wide variety of different types of testing, including testing that does not strictly involve a sequence of request/response transactions. There are many different methods for guaranteeing global determinism in Markov processes in addition to the Metropolis-Hastings method, and any of these methods can be used in implementations of the currently disclosed probabilistic testing methods. Of course, any of many different design and implementation parameters, including programming language, operating system, virtualization layer, hardware platform, modular organization, data structures, control structures, and other such parameters can be varied to produce alternative implementations of the currently disclosed probabilistic testing methods and systems. Although the described implementation includes a test application that runs a test session specified in a test file, alternative implementations may obtain configuration information through an interactive user interface or from other information sources. A test system can be any of various types of individual physical computer systems or virtual machines that run testing applications or may be a distributed computer system in which multiple physical computer systems or virtual computer systems run multiple testing applications. A test application may itself carry out multiple discrete testing sessions to test multiple target electronic devices and computer systems.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A testing system comprising:
one or more computer systems, each computer system including one of more memories, one or more processors, and an application-execution environment;
one or more testing applications that each executes in one or more application-execution environments within the one or more computer systems to control one or more test sessions, each test session testing a target device or target system; and
one or more digitally encoded representations of a Markov process used by the one or more test sessions to generate a testing load to test the target device or target system.

2. The testing system of claim 1
wherein each digitally encoded representation of a Markov process includes representations of two or more states and representations of probability-associated state transitions that each specifies a transition from a first state to one of a second state and the first state; and
wherein the Markov process is a sequence of steps, each step comprising a state transition selected from the digitally encoded representation of the Markov process based on a random or pseudorandom number generated for the step and effected by transmitting a request or command to the target device or target system.

3. The testing system of claim 2
wherein each test session comprises a sequence of requests or commands sent from the test application controlling the test session to the target device or target system based on a digitally encoded Markov process associated with the test session; and
wherein the sequence of requests or commands is generated by
iteratively
carrying out a step of the Markov process based on a current target state to determine a next request or command,
transmitting the next request or command to the target system,
receiving a response to the next request, and
determining the current target state following transmission of the next request or command to the target system,
until a session-terminating event occurs.

4. The testing system of claim 3 wherein the current target state is determined from the most recent request message sent to the target system and from the received response.

4. The testing system of claim 3
wherein the step of the Markov process identifies a state transition from the current target state to a following target state corresponding to the next step; and
wherein, when the current target state following transmission of the next request or command to the target system is not equal to the following target state, an anomaly or failure is counted or reported by the testing application.

6. The testing system of claim of claim 3 wherein carrying out a step of the Markov process based on a current target state to determine a next request or command further comprises:
generating the random or pseudorandom number;
mapping the random or pseudorandom number to a segment of the real-number line containing contiguous subsegments, each subsegment having a length proportional to a probability associated with a state transition from the current target state to one of another target state and the current target state;
selecting, as a next target state, the state associated with a subsegment to which the random or pseudorandom number maps, and
selecting a request that induces a transition from the current target state to the next target state.

7. The testing system of claim of claim 3 wherein carrying out a step of the Markov process based on a current target state to determine a next request or command further comprises:
generating the random or pseudorandom number;
mapping the random or pseudorandom number to a segment of the real-number line containing contiguous subsegments, each subsegment having a length proportional to a probability associated with a state transition from the current target state to one of another target state and the current target state;
selecting, as a proposed next target state, the state associated with a subsegment to which the random or pseudorandom number maps;
determining an acceptance ratio for the proposed next target state as a probability of the proposed next target state multiplied by the state-transition probability for transitioning from the proposed next target state to the current target state divided by a probability of the current state multiplied by the state-transition probability for transitioning from the current target state to next target state;
when the acceptance ratio is less than 1,
generating a second random or pseudorandom number, and
when the second random or pseudorandom number is greater than the acceptance ratio,
selecting the current target state as the next target state,
when the second random or pseudorandom number is less than or equal to the acceptance ratio,
selecting the proposed next target state as the next target state; and
when the acceptance ratio is greater than or equal to 1,
selecting the proposed next target state as the next target state; and
selecting a request that induces a transition from the current target state to the next target state.

8. The testing system of claim 3 wherein the testing system maintains counts of one or more of expected state transitions and unexpected state transitions and wherein the testing system outputs test statistics based on these counts to a display device and/or output device.

9. The testing system of claim 2 where session-terminating events include:
carrying out a number of steps greater than a specified maximum number of steps; and
a current time exceeds a time point specified for terminating the test session.

10. The testing system of claim 2 wherein each state is connected to all other states by a path comprising one or more state transitions so that it is possible, from a given state, to reach any other state by a finite sequence of state transitions.

11. The testing system of claim 2 wherein the Markov process exhibits a stationary equilibrium distribution of state probabilities, where the probability of a state is a probability that the target system will occupy that state at any given step following an initial set of steps.

12. The testing system of claim 10 wherein a set of state probabilities for the states of a representation of a Markov process are input to the testing session along with the representation of a Markov process, configuration information, and a representation of request/response transactions each associated with a state transition in the Markov process.

13. A method that tests a target, system or target device, the method comprising:
receiving test-configuration information;
establishing a connection to the target system or target device; and
issuing a sequence of requests or commands to the target system or target device by
iteratively
carrying out a step of a Markov process specified in the test-configuration information based on a current target state to determine a next request or command,
transmitting the next request or command to the target system or target device,
receiving a response to the next request, and
determining a current target state following transmission of the next request or command to the target system,
until a session-terminating event occurs.

14. The method of claim 13
wherein the representation of the Markov process includes representations of two or more states and representations of probability-associated state transitions that each specifies a transition from a first state to one of a second state and the first state; and
wherein each step of the Markov process corresponds to a state transition selected from the representation of the Markov process based on a random or pseudorandom number generated for the step and effected by transmitting a request or command to the target device or target system.

15. The method of claim 14 wherein the current state target state is determined from the most recent request message sent to the target system and by the received response.

16. The method of claim 14 wherein carrying out a step of the Markov process based on a current target state to determine a next request or command further comprises:
generating the random or pseudorandom number;
mapping the random or pseudorandom number to a segment of the real-number line containing contiguous subsegments, each subsegment having a length proportional to a probability associated with a state transition from the current target state to one of another target state and the current target state;
selecting, as a next target state, the state associated with a subsegment to which the random or pseudorandom number maps, and
selecting a request that induces a transition from the current target state to the next target state.

17. The method of claim of claim 14 wherein carrying out a step of the Markov process based on a current target state to determine a next request or command further comprises:
generating the random or pseudorandom number;
mapping the random or pseudorandom number to a segment of the real-number line containing contiguous subsegments, each subsegment having a length proportional to a probability associated with a state transition from the current target state to one of another target state and the current target state;
selecting, as a proposed next target state, the state associated with a subsegment to which the random or pseudorandom number maps;
determining an acceptance ratio for the proposed next target state as a probability of the proposed next target state multiplied by the state-transition probability for transitioning from the proposed next target state to the current target state divided by a probability of the current state multiplied by the state-transition probability for transitioning from the current target state to next target state;
when the acceptance ratio is less than 1,
generating a second random or pseudorandom number, and
when the second random or pseudorandom number is greater than the acceptance ratio,
selecting the current target state as the next target state.
when the second random or pseudorandom number is less than or equal to the acceptance ratio,
selecting the proposed next target state as the next target state; and
when the acceptance ratio is greater than or equal to 1,
selecting the proposed next target state as the next target state; and
selecting a request that induces a transition from the current target state to the next target state.

18. The method of claim 13 wherein the testing system maintains counts of one or more of expected state transitions and unexpected state transitions and wherein the testing system outputs test statistics based on these counts to a display device and/or output device.

19. The method of claim 13 where session-terminating events include:
carrying out a number of steps greater than a specified maximum number of steps; and
a current time exceeds a time point specified for terminating the test session.

20. Computer instructions encoded in a physical data storage device of a computer system including one or more memories, one or more processors, and an application-execution environment, that control the computer system to test a target system or target device by:
receiving test-configuration information;
establishing a connection to the target system or target device; and
issuing a sequence of requests or commands to the target system or target device by
iteratively
carrying out a step of a Markov process specified in the test-configuration information based on a current target state to determine a next request or command,
transmitting the next request or command to the target system or target device,
receiving a response to the next request, and
determining a current target state following transmission of the next request or command to the target system or target device,
until a session-terminating event occurs.
